(19) United States
(12) Patent Application Publication
(10) Pub. No.: US 2011/0280414 A1
(43) Pub. Date: Nov. 17, 2011

(54) FUZZY WOOFIES: ONE-WAY COMMUNICATION BETWEEN TWO WIRELESS AUDIO HEADPHONE COMMUNICATION SYSTEMS RECEIVING AUDIO FROM AN AUDIO SOURCE

(76) Inventor: Virginia Johanna Intelisano, Brooklyn, NY (US)

(21) Appl. No.: 13/073,712

(22) Filed: Mar. 28, 2011

Related U.S. Application Data
(60) Provisional application No. 61/342,059, filed on Apr. 9, 2010.

(51) Int. Cl. H04B 3/00

(52) U.S. Cl. 381/77

(57) ABSTRACT

Two wireless audio headphone communication systems each have an audio input for receiving audio signals from an audio source. The wireless transceivers receive and transmit radio frequency communications including audio signals that conform to wireless audio protocols of wireless communication protocols. A wireless audio headphone communication system sends sound over a one-way radio frequency to a receiver, the second wireless audio headphone communication system.

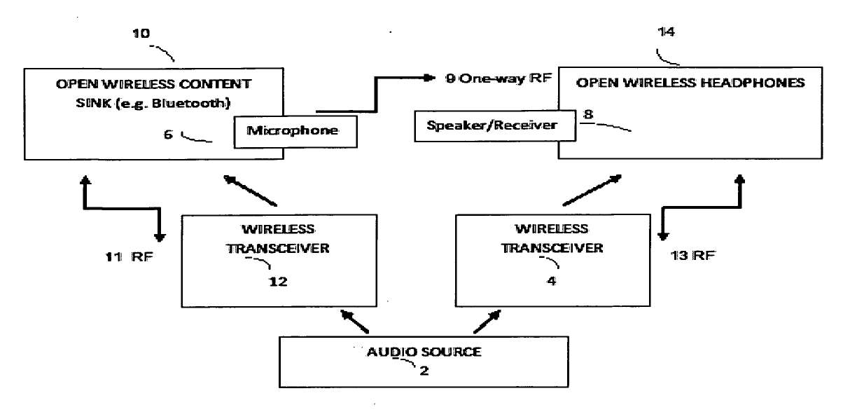

### CROSS-REFERENCES TO RELATED APPLICATIONS

This application is a continuation of and claims priority from U.S. Provisional Patent Application 61/342,059, which claims the benefit of the filing date of Apr. 9, 2010.

### STATEMENT REGARDING FEDERALLY SPONSORED RESEARCH AND DEVELOPMENT

Not Applicable

### BACKGROUND OF THE INVENTION

The present invention relates to two wireless audio headphone communication systems communicating audio signals, in particular, through one-way radio frequency functionality (e.g., baby monitor).

### BRIEF SUMMARY OF THE INVENTION

Stereo headphones and other audio output devices that conform to the Audio Profile of the Bluetooth radio frequency (RF) wireless standard can utilize sources of audio content from a variety of Bluetooth enabled audio platforms and the present invention relates to these Bluetooth enabled audio platforms: iPod Touch, iPad, iPhone, or Android. There are communications present including audio signals that conform to wireless audio communication protocols. The audio source is a player (e.g., iPod Touch, iPad, iPhone, or Android) that delivers music or other content to the wireless audio headphone communication systems.

The present invention provides two wireless audio headphone communication systems having audio input for receiving audio signals from an audio source. The present invention provides two wireless transceivers for receiving and transmitting radio frequency communications to the wireless audio headphones and the wireless content sink (e.g., Bluetooth).

The present invention provides the wireless content sink (e.g., Bluetooth) which sends sound over a one-way radio frequency to a receiver, the wireless headphones. The one-way audio signal conforms to one-way radio frequency communication protocols (e.g., baby monitor). More expensive baby monitor models are built with higher frequency abilities that can eliminate outside interferences. Select baby monitors that come with a scrambler can minimize and remove any outside interference. Additional objects and advantages of the present invention will be apparent from the detailed description of the preferred embodiment thereof, which proceeds with reference to the accompanying drawings.

### BRIEF DESCRIPTION OF THE DRAWINGS

The drawing is a block diagram of a one-way RF between two wireless audio headphone communication systems receiving audio from an audio source.

### DETAILED DESCRIPTION OF THE DRAWINGS

The drawing is a block diagram of two wireless audio headphone communication systems, the open wireless content sink 10 (e.g. Bluetooth) and the open wireless headphones 14. The open wireless headphones 14 include a Speaker/Receiver 8. The open wireless content sink 10 (e.g. Bluetooth) includes a Microphone 6. The Microphone 6 sends a one-way radio frequency to the Speaker/Receiver 8. Audio playing software which is coming from the Audio Source 2 (iPod Touch, iPad, iPhone, or Android) provides audio content which is received by the two wireless audio headphone communication systems 10, 14, respectively and simultaneously. It will be appreciated that reference to the Bluetooth wireless standard is merely as an example and that RF links 11, 13 respectively could operate according to any wireless standard. In addition, the one-way RF link 9 operates according to one-way radio frequency standard.

### DECLARATION

Inventor having described and illustrated the principles of my invention with reference to an illustrated embodiment it will be recognized that the illustrated embodiment can be modified in arrangement and detail without departing from such principles. It should be understood that the programs, processes or methods described herein are not related or limited to any particular type of wireless audio apparatus, unless indicated otherwise. Various types of general purpose or specialized wireless audio apparatus may be used with or perform operations in accordance with the teachings described herein.

In view of the many possible embodiments to which the principles of my invention may be applied, it should be recognized that the detailed embodiments are illustrative only and should not be taken as limiting the scope of my invention. Rather, I claim as my invention all such embodiments as may come within the scope and spirit of the following claims and equivalents thereto.

What is claimed is:

1. Two wireless audio communication systems comprising: audio inputs for receiving audio signals from an audio source; wherein the communications including an audio signal conforms to wireless communication protocols; two wireless transceivers for transceiving wireless communications to wireless headphones and wireless content sink according to wireless communication protocols; two wireless transceivers for receiving and transmitting radio frequency communications with each wireless audio communication systems (e.g. Bluetooth and wireless headphones) according to wireless communication protocols

2. Two wireless audio communication systems comprising: a microphone for sending a one-way radio frequency signal from the wireless content sink to; a speaker/receiver, the wireless headphones; wherein the microphone has abilities to send one-way radio frequency to a speaker/receiver; communications including a one-way audio signal conforms to one-way radio frequency communication protocols; and audio inputs for receiving audio signals from an audio source; wherein the communications including an audio signal conforms to wireless communication protocols; Two wireless transceivers for transceiving wireless communications to wireless headphones and wireless content sink according to wireless communication protocols; two wireless transceivers for receiving and transmitting radio frequency communications with each wireless audio communication systems (e.g. Bluetooth and wireless headphones) according to wireless communication protocols.

3. The wireless audio communication systems of claims 1 and 2 in which the audio input receives the audio signal from the audio source.

4. The wireless audio communication systems of claims 1 and 2 of which the audio source is in communication with the two wireless transceivers for receiving and transmitting radio frequency communications with each wireless audio communication system (e.g. Bluetooth and wireless headphones) according to wireless communication protocols.

5. The wireless audio communication systems of claims 1 and 2 of which the audio source is included in a Bluetooth enabled audio platform: iPod Touch, iPad, iPhone, or Android.

6. The wireless audio communication systems of claims 1 and 2 for transceiving the audio signals between the audio source and the wireless audio communication systems.

7. The wireless audio communication systems of claims 1 and 2 of which the audio source does not include a driver for the wireless communication protocol.

8. A wireless audio communication systems comprising: a wireless headphone, wherein the headphone is configured to wirelessly receive an audio signal, and wherein the headphone is configured to wirelessly transceive audio signals wherein the audio signals transceived by the headphones conform to a wireless audio protocol; and a wireless content sink, wherein the content sink is configured to wirelessly receive an audio signal, and wherein the content sink is configured to wirelessly transceive audio signals wherein the audio signals transceived by the content sink conform to a wireless audio protocol; a microphone in the content sink is configured to send the one-way radio frequency to the wireless speaker/receiver in the wireless headphones; and a wireless transceiver configured to transceive wireless communications with the wireless audio headphone communication systems on behalf of the computing device, wherein the wireless communications comprise the audio signals and radio frequencies; the audio signals between the audio source and the transceivers; and the wireless audio communication systems.
